(19) United States
(12) Patent Application Publication
(10) Pub. No.: US 2016/0010814 A1
(43) Pub. Date: Jan. 14, 2016

(54) WATERPROOF LIGHT EMITTING DIODE LAMP AND LAMP STRING STRUCTURE USING THE SAME

(71) Applicant: Semisilicon Technology Corp., New Taipei City (TW)

(72) Inventor: Wen-Chi PENG, New Taipei City (TW)

(21) Appl. No.: 14/327,376

(22) Filed: Jul. 9, 2014

(51) Int. Cl. F21S 4/00; F21V 23/00; F21V 31/00

(52) U.S. Cl. CPC F21S 4/001; F21V 31/005; F21V 23/003

(57) ABSTRACT

A waterproof light emitting diode lamp includes an emitting module, a plurality of transmission cables, an injection molding layer, and a lampshade. The emitting module has an LED lamp, a plurality of conductive holders, a shield, and a driving circuit. The driving circuit is disposed inside the LED lamp. The conductive holders are electrically coupled to the driving circuit and are exposed from one side of the LED lamp. The shield is connected to the LED lamp, and the conductive holders are arranged in a line at one side of the shield. The plurality of transmission cables are electrically coupled to the conductive holders correspondingly. The injection molding layer wraps a connection area from the emitting module to the transmission cables, and the LED lamp and the transmission cables are partially exposed from the injection molding layer.

### BACKGROUND

1. Technical Field

The present invention relates to a light emitting diode lamp, and particularly to a waterproof light emitting diode lamp and a light string structure using the same.

2. Related Art

With the fast development of technology, a light emitting diode (LED) increasingly replaces a traditional incandescent light bulb and becomes a mainstream for illumination. The LED is popularly adopted in all kinds of lamps. Examples of LED devices include an LED light bulb, an LED light panel, an LED light tube and etc. Further, examples of LED display products include an LED display panel, an LED light string and etc.

The light strings are usually used to create lighting effects for decorations and atmosphere during events, festivals or activities. The conventional LED light string has a plurality of LEDs connected by electrical wires. To connect the conventional LED to the electrical wire, a required portion of an insulating layer of the electrical wire is removed to expose a core portion, and then the exposed core portion of the electrical wire is electrically connected to the pins of the LED, after that, insulation is applied for insulating wrapping.

However, due to the cross-shaped arrangement of the pins of the conventional LED, the insulation formed by injection molding is liable to have cavities or bubbles, and thereby the injection molding has a low permeability. Such a problem also incurs moisture permeation/storage, which is one reason causing the LED light string to be short-circuited or damaged.

Therefore, industries in the related fields have to work out solutions to improve the above-mentioned issues.

### BRIEF SUMMARY

It is an object of the present invention to provide a waterproof light emitting diode (LED) lamp can prevent moisture from entering the lamp and prolong a lifespan of the lamp.

Accordingly, the present invention provides a waterproof LED lamp, comprising an emitting module, a plurality of transmission cables, an injection layer, and a lampshade. The emitting module includes an LED lamp, a plurality of conductive holders, a shield, and a driving circuit. The driving circuit is disposed inside the LED lamp. The conductive holders are electrically coupled to the driving circuit and one side of each conductive holder protrudes beyond the LED lamp. The shield is connected to the LED lamp, and the conductive holders are arranged in a line at one side of the shield. The transmission cables are electrically coupled to the conductive holders correspondingly. The injection molding layer wraps a connection area from the emitting module to the transmission cables, and the LED lamp and the transmission cables are partially exposed from the injection molding layer.

It is another object of the present invention to provide a lamp string structure which has LED lamps in series connection and effectively control a flickering effect of the LED lamps.

In order to achieve the above-mentioned object, the present invention provides a lamp string structure comprising a plurality of emitting modules, a plurality of transmission cables, an injection molding layer, and a lampshade. The driving circuit is disposed inside the LED lamp. The conductive holders are electrically coupled to the driving circuit and one side of each conductive holder protrudes beyond the LED lamp. The shield is connected to the LED lamp, and the conductive holders are arranged in a line at one side of the shield. The transmission cables are electrically coupled to the conductive holders, correspondingly, wherein one end of each transmission cable is electrically coupled to the corresponding conductive holder, and the other end of each transmission cable is electrically coupled to the adjacent emitting module. The injection molding layer wraps a connection area from each of the emitting modules to the transmission cables, and the LED lamp and the transmission cables are partially exposed from the injection molding layer.

Compared to conventional techniques, the present invention has following effects. A plurality of conductive holders arranged in a line against the shield and electrically coupled to transmission cables correspondingly in an effective manner to enhance reliability. Further, since the aforesaid conductive holders are against the shield in a parallel manner, a surface tension caused by capillary action is reduced, and as a result, an injection molding layer is easy to fill up and completely enclose a connection area from an emitting module to the transmission cables, thereby preventing moisture permeation/storage. In addition, the injection molding layer has a grooving to engage with a flange of the lampshade, so the moisture is effectively prevented from entering into the emitting module and prolong a lifespan of the lamp.

The lamp string structure of the present invention has a control chip, electrically coupled to at least one emitting chip to control the turn on and turn off of each emitting chip and a lighting effect of the each emitting module.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a partial top view of a light emitting diode lamp according to a first embodiment of the present invention.

FIG. 2 shows a partially lateral view of the first embodiment of FIG. 1.

FIG. 3 shows an explosion diagram illustrating an emitting module coupled to the transmission cables according to the present invention.

FIG. 4 shows a schematic view illustrating an insulating cover to engage with the transmission cables according to the present invention.

FIG. 5 shows a schematic view illustrating injection-molding after the emitting module and the transmission cables are coupled together according to the present invention.

FIG. 6 shows a schematic view illustrating a combination of the emitting module and the lampshade after injection-molding.

FIG. 7 shows an assembly diagram according to FIG. 6.

FIG. 8 shows a cross-sectional view of FIG. 7.

FIG. 9 shows a partially schematic diagram of a second preferred embodiment of the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

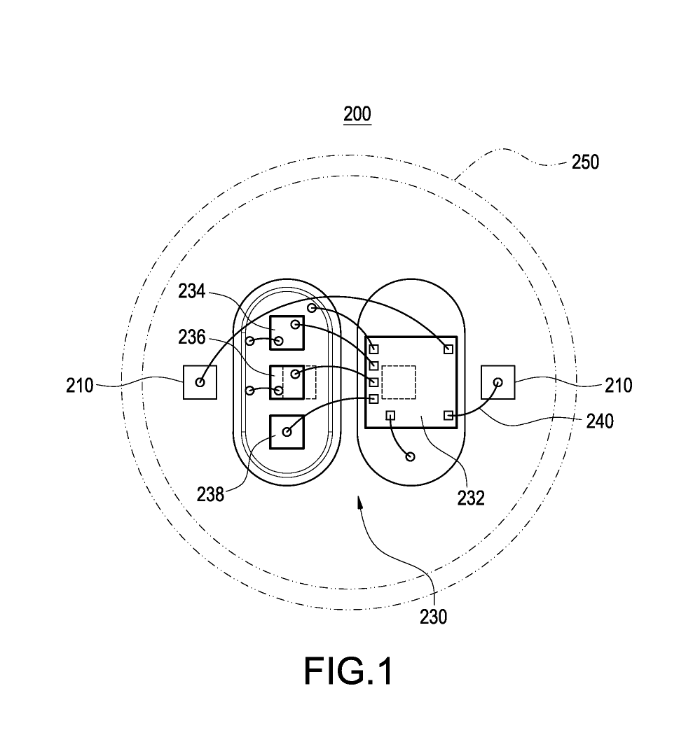

As shown in FIG. 1 to FIG. 7, the present invention provides a waterproof light emitting diode (LED) lamp 10, comprising an emitting module 100, a plurality of transmission cables 300, an injection molding layer 400, and a lampshade 500. According to a preferred embodiment shown in FIG. 1 to FIG. 3, the emitting module 100 comprises an LED lamp 200, a plurality of conductive holders 210, a shield 220, and a driving circuit 230.

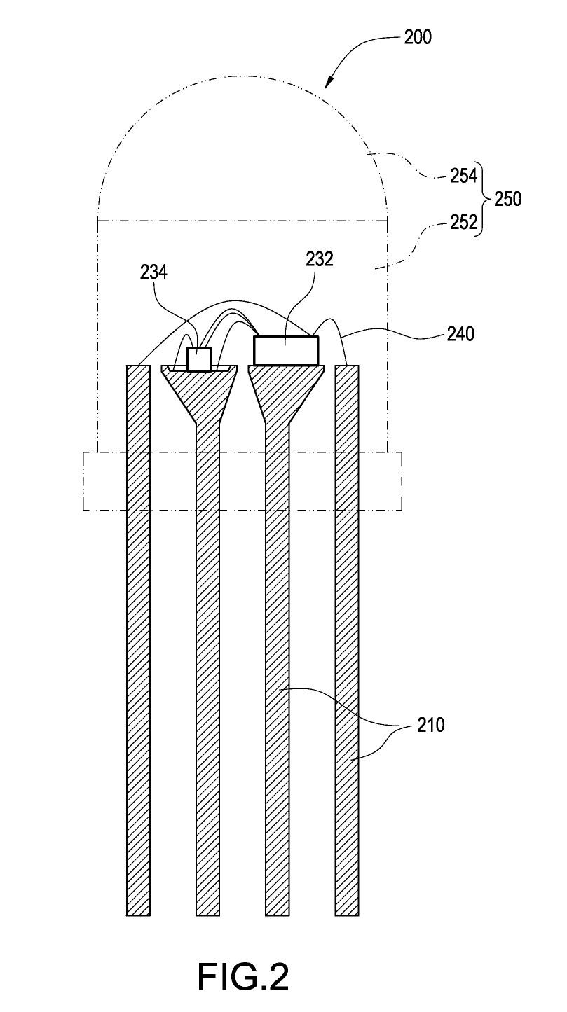

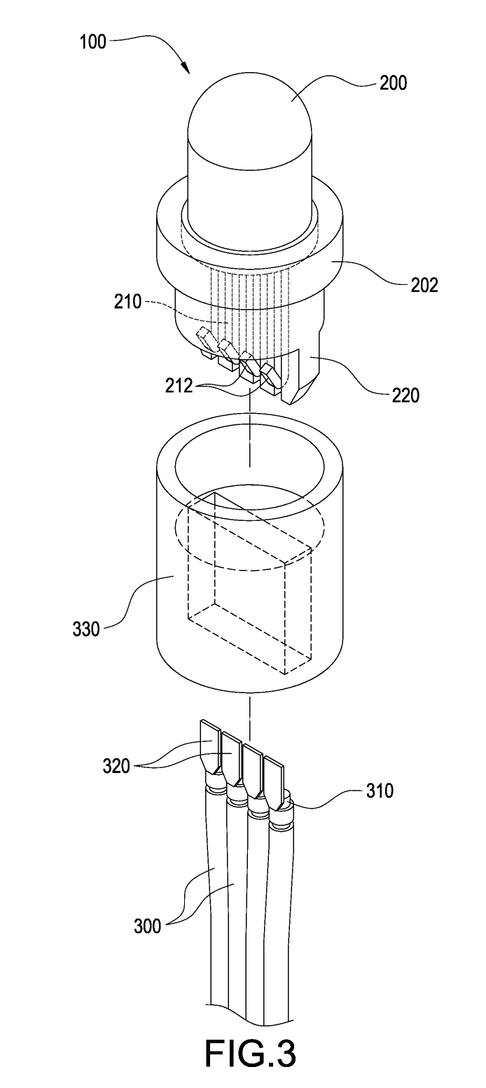

As FIG. 1 and FIG. 2 shown, the driving circuit 230 is disposed inside the LED lamp 200. The aforesaid conductive holders 210 are electrically coupled to the driving circuit 230 and one side of the conductive holders 210 protrude beyond one side of the LED lamp 200. Referring to FIG. 3, the shield 220 is connected to a lower end of the LED lamp 200. As shown in FIG. 3, the shield 220, coupling to the LED lamp 200, is substantially a body 202 made of plastic or other suitable materials. The body 202 is, for example, a lamp base. The shield 220 is preferably perpendicular to the driving circuit 230 and parallel to the conductive holders 210, and the conductive holders 210 are against one side of the shield 220. The conductive holders 210 mentioned above are preferably made of metal having preferable electrical conductivity. The number of the conductive holders 210 includes 4 but is not limited thereto.

It should be noted that the driving circuit 230 further comprises a control chip 232 and at least one emitting chip 234. According to the embodiment shown in FIG. 1, the emitting chip 234 preferably includes three kinds of grains, i.e. the grain of red light(R), the grain of green light(G), and the grain of blue light(B); however, it can apply at least one kind of grain. By means of leads 240, the emitting chips 234,236, and 238 are connected to the control chip 232 and each of the conductive holders 210. The aforesaid emitting chips 234, 236, and 238 are controlled by the control chip 232 to properly emit light and/or combined emit light. Since the emitting chips 234, 236, and 238 and the control chip 232 are well known in the art, detailed descriptions are not made here.

As shown in FIG. 1 and FIG. 2, the LED lamp 200 further comprises a lens 250, a sealed portion 252, and a refractive portion 254. The driving circuit 230 is preferably disposed on platforms of two of the four conductive holders 210. However, in different embodiments, the driving circuit 230 can be disposed on a platform of only one conductive holder 210. The transparent lens 250 is partially filled with a sealed portion 252, and a refraction portion 254 is formed opposite to the sealed portion 252. In other words, the refraction portion 254 is a hollow space without being filled with silica gel or the likes, and can refract lights by the lens 250. The sealed portion 252 fixes the driving circuit 230 inside the LED lamp 200.

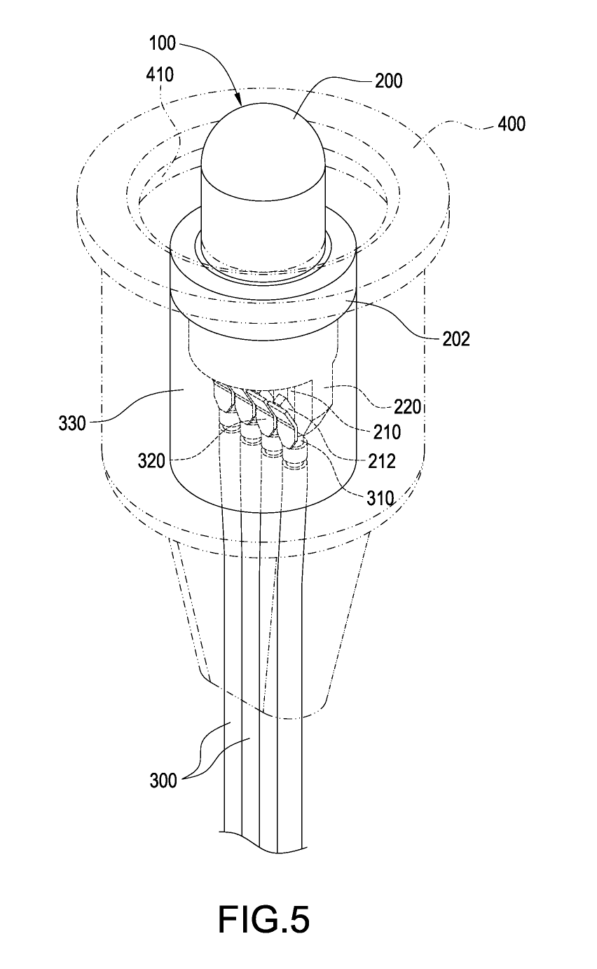

As FIG. 3 and FIG. 5 shown, each of the transmission cables 300 is electrically coupled to the conductive holders 210 respectively. In the embodiment shown in FIG. 3, when coupling the emitting module 100 to the transmission cables 300, the conductive holders 210 form a bending portion 212 by means of a tools or a mold. The bending portion 212 is formed opposite to the driving circuit 230, so as to contact the transmission cables 300. In the present embodiment, each of the transmission cables 300 further comprises a core 310 and an insulating cover 330. For coupling successfully and other purposes, terminals 320 are provided to couple the cores 310 of the transmission cables 300 correspondingly.

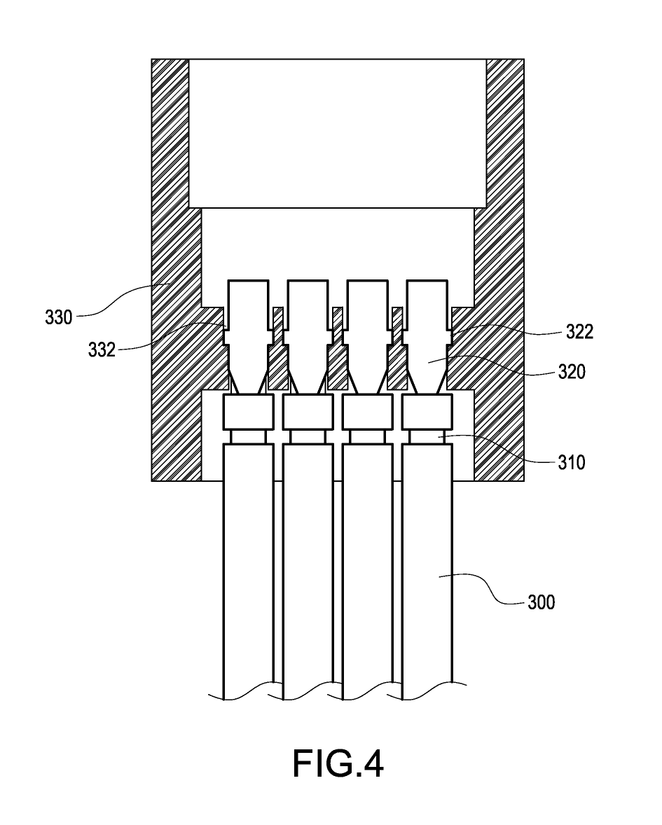

The shape of the insulating cover 330 is substantially similar to the body 202 of the LED lamp 200 to engage with the body 202. Please refer to FIG. 4, the insulating cover 330 further includes a plurality of clasping holes 332. Each of the terminals 320 of the transmission cables 300 further has at least one stuck point 322. The at least one stuck point 322 is disposed on one side of the terminal 320 for engaging with the clasping hole 332.

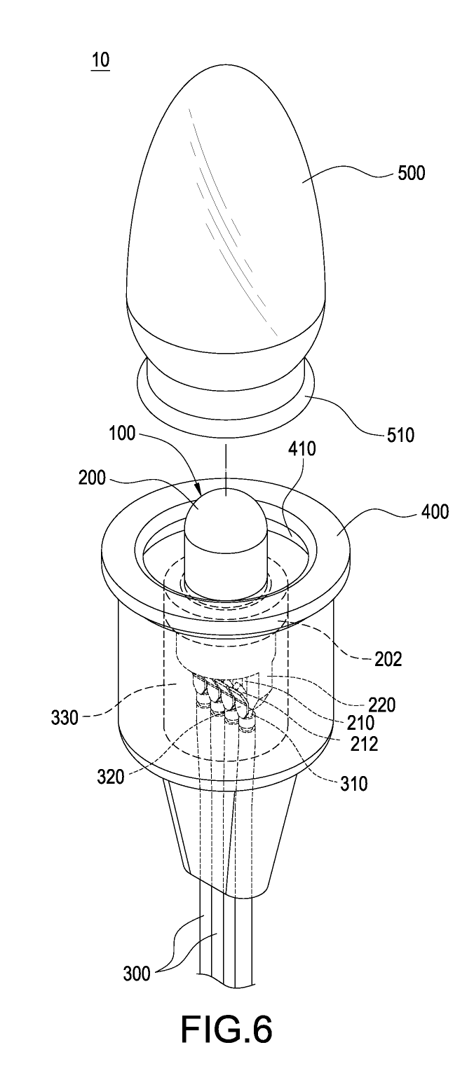

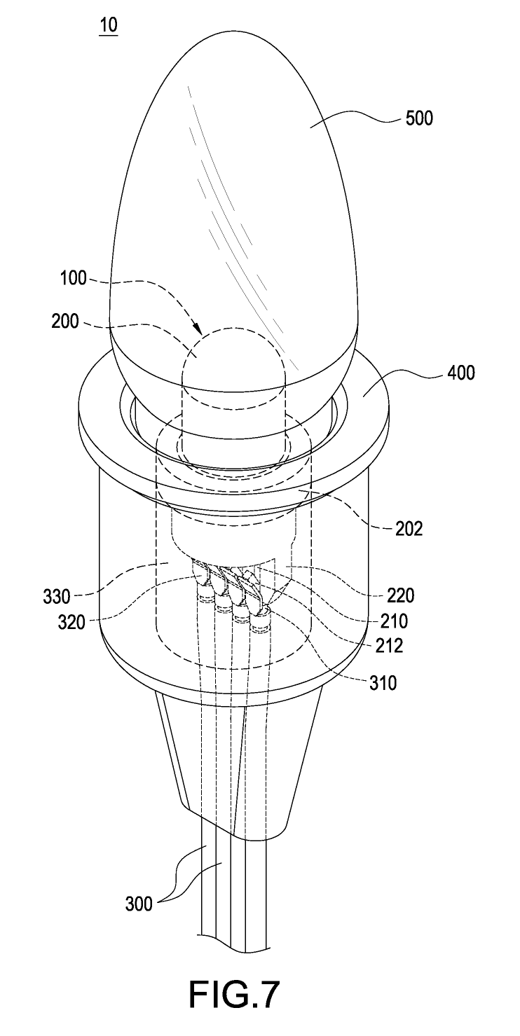

As FIG. 5 shown, after the insulating cover 330 enclosed the shield 220, an injection molding mold is used to form an injection molding layer 400. After the injection molding layer 400 is cooled to retain a fixed shape, as shown in FIG. 6 and FIG. 7, the injection molding layer 400 preferably wraps the emitting module 100 and the transmission cables 300. However, the LED lamp 200 and the transmission cables 300 are partially exposed from the injection molding layer 400, wherein the injection molding layer 400 further has a grooving 410 in an upper end thereof.

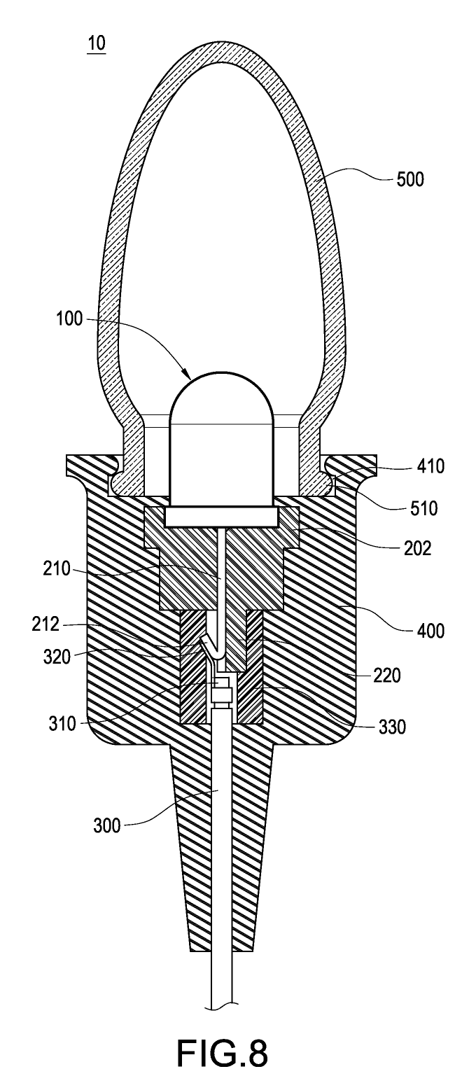

The lampshade 500 covers the LED lamp 200 of the emitting module 100, and the lampshade 500 has a flange 510 at a lower end thereof to engage with the grooving 410, as shown in FIG. 8. According to the embodiment shown in FIG. 8, the flange 510 of the lampshade 500 properly engages with the grooving 410 of the injection molding layer 400, so as to prevent moisture from entering into the emitting module 100. Furthermore, the conductive holders 210 disposed in a line against the shield 220 have effects as follows: the conductive holders 210 are electrically coupled to the terminals 320 of the transmission cables 300, in addition to that, since the conductive holders 210 are arranged in a line parallel to the shield 220 which the conductive holders 210 are against, the injection molding layer 400 is easy to fill up and wrap the emitting module 100 and the transmission cables 300, thereby preventing moisture from getting into and being stored inside.

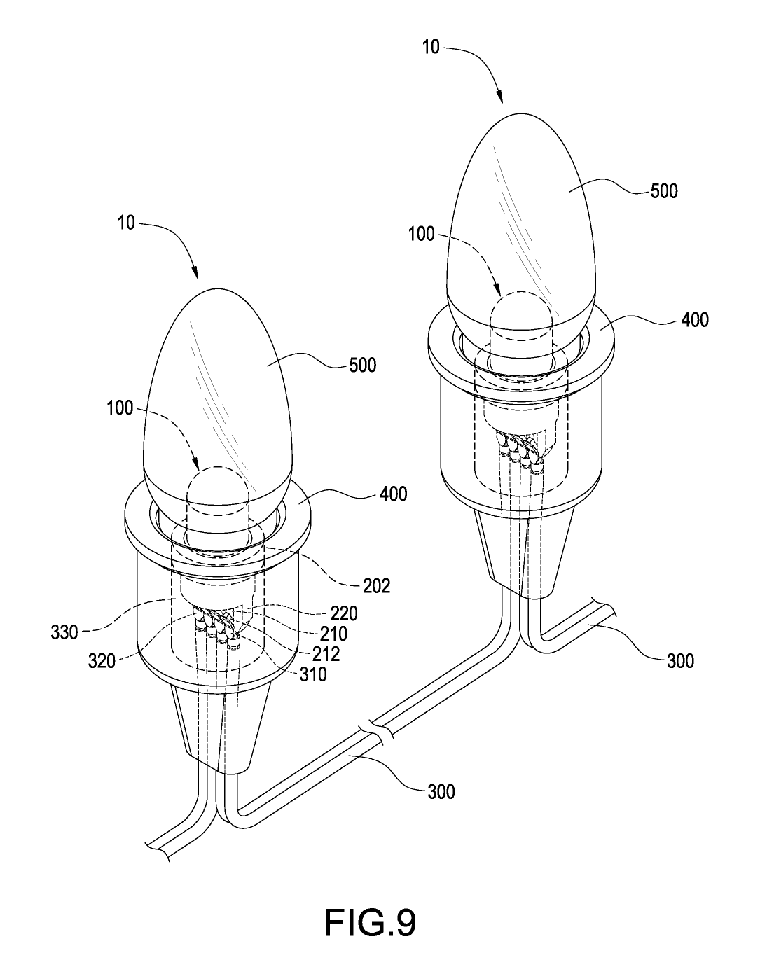

Referring to FIG. 9, a lamp string structure is shown according to a second embodiment of the present invention. The lamp string structure of the present invention comprises a plurality of waterproof light emitting diode lamps 10, wherein each of the waterproof light emitting diode lamps 10 includes an emitting module 100, a plurality of transmission cables 300, an injection molding layer 400, and a lampshade 500. The lamp string structure of the present invention is constituted by joining up the waterproof light emitting diode lamps 10 in series. According to the present invention, the emitting module 100, the transmission cables 300, the injection molding layer 400, the lampshade 500, and their connection relations therebetween are the same as the first embodiment hereinbefore and thus are not repeated herein.

The waterproof light emitting diode lamps 10 are connected in series through transmission cables 300. To be specific, the transmission cable 300 is categorized into four kinds of transmission cables 300 in total, including a transmission cable connected to an anode (Vcc), a transmission cable connected to a ground (Gnd) and two signal transmission cables. The four kinds of transmission cables 300 are respectively coupled to the conductive holders 210, thereby achieving the serial connection. The details about how to achieve the serial connection are conventional and hence are not repeated herein.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A waterproof light emitting diode lamp, comprising:
an emitting module, including a light emitting diode (LED) lamp, a plurality of conductive holders, a shield, and a driving circuit, the driving circuit disposed inside the LED lamp, the plurality of the conductive holders electrically coupled to the driving circuit, one side of each conductive holder protruding beyond the LED lamp, the shield connected to the LED lamp, wherein the conductive holders are arranged in a line at one side of the shield, and the driving circuit includes a control chip and at least one emitting chip;
a plurality of transmission cables electrically coupled to the conductive holders; and
an injection molding layer wrapping a connection area from the emitting module to the plurality of transmission cables, the LED lamp and the transmission cables partially exposed from the injection molding layer.

2. The waterproof light emitting diode lamp in claim 1, wherein the transmission cables further comprise an insulating cover to engage with the shield.

3. The waterproof light emitting diode lamp in claim 2, wherein the insulating cover further includes a plurality of clasping holes, each of terminals of the transmission cables further includes at least one stuck point, the at least one stuck point is disposed on one side of the terminal for engaging with the clasping hole.

4. The waterproof light emitting diode lamp in claim 1, wherein the conductive holders further comprise a bending portion, the bending portion is formed opposite to the driving circuit.

5. The waterproof light emitting diode lamp in claim 1, further comprises a plurality of the terminals, wherein each of the transmission cables further includes a core, the terminals are respectively correspondingly coupled to the cores of the transmission cables for electrically connecting to the conductive holders.

6. The waterproof light emitting diode lamp in claim 1, further comprises a lampshade to cover the LED lamp of the emitting module, wherein the injection molding layer further includes a grooving, the end of the lampshade includes a flange to engage with the grooving.

7. The waterproof light emitting diode lamp in claim 1, wherein the shield is perpendicular to the driving circuit and is parallel to the conductive holders.

8. The waterproof light emitting diode lamp in claim 1, wherein the LED lamp further comprises a lens, a sealed portion, and a refractive portion, the driving circuit is disposed on two of the conductive holders, the lens is partially filled with the sealed portion, the refractive portion is formed opposite to the sealed portion, and the driving circuit is fixed inside the LED lamp by the sealed portion.

9. A lamp string structure, comprising:
a plurality of emitting modules, each of the emitting modules including an LED lamp, a plurality of conductive holders, a shield, and a driving circuit, the driving circuit disposed inside the LED lamp, the conductive holders electrically coupled to the driving circuit and one side of each conductive holder protruding beyond the LED lamp, the shield connected to the LED lamp, wherein the conductive holders are arranged in a line at one side of the shield, and the driving circuit includes a control chip and at least one emitting chip;
a plurality of transmission cables, one end of each of the transmission cables electrically coupled to each of the conductive holders, and the other end of each of the transmission cables being electrically coupled to the emitting modules; and
an injection molding layer, the injection molding layer wrapping a connection area from the emitting module to the transmission cables, and the LED lamp and the transmission cables being partially exposed from the injection molding layer.

10. The lamp string structure in claim 9, wherein the transmission cables further comprises an insulating cover to engage with the shield.

11. The waterproof light emitting diode lamp in claim 10, wherein the insulating cover further includes a plurality of clasping holes, each of the terminals of the transmission cables further includes at least one stuck point, the at least one stuck point is disposed on one side of the terminal for engaging with the clasping hole.

12. The lamp string structure in claim 9, wherein the conductive holders further comprise a bending portion, the bending portion is formed opposite to the driving circuit.

13. The lamp string structure in claim 9, further comprises a plurality of terminals, wherein each of the transmission cables further includes a core, and the terminals are respectively correspondingly coupled to the core of the transmission cables for electronically connecting to the conductive holders.

14. The lamp string structure in claim 9, further comprises a lampshade to cover the LED lamp of the emitting module, wherein the injection molding layer further includes a grooving, the end of the lampshade includes a flange to engage with the grooving.

15. The lamp string structure in claim 9, wherein the shield is perpendicular to the driving circuit and is parallel to the conductive holders.

16. The lamp string structure in claim 9, wherein the LED lamp further comprises a lens, a sealed portion, and a refraction portion, the driving circuit is disposed on two of the conductive holders, the lens is partially filled with the sealed portion, the refraction portion is formed opposite to the sealed portion, and the driving circuit is fixed inside the LED lamp by the sealed portion.
